(19) United States
(12) Patent Application Publication
(10) Pub. No.: US 2012/0101720 A1
(43) Pub. Date: Apr. 26, 2012

(54) STORAGE MEDIUM SAVING PROGRAM AND CAPABLE OF BEING READ BY COMPUTER, COMPUTER PROGRAM PRODUCT, NAVIGATOR AND CONTROL METHOD THEREOF

(75) Inventor: WEI-CHIANG CHO, Taoyuan County (TW)

(73) Assignee: MITAC INTERNATIONAL CORP., TAOYUAN COUNTY (TW)

(21) Appl. No.: 13/011,705

(22) Filed: Jan. 21, 2011

(30) Foreign Application Priority Data
Oct. 25, 2010 (TW) 099136400

(51) Int. Cl. G01C 21/36

(52) U.S. Cl. 701/414

(57) ABSTRACT

The invention discloses a storage medium storing program capable of being read by a computer, a computer program product, a navigator and a control method thereof. The navigator comprises a positioning unit, an image capturing unit and a processing unit. The positioning unit locates the navigator and correspondingly provides a position information, and the image capturing unit captures a plurality of rode images. The processing unit determines if the navigator enters a turn state according to a navigation route and the position information. When the navigator enters the turn state, the processing unit controls the image capturing unit to capture the plurality of rode images.

### BACKGROUND OF THE INVENTION

1. Field of the Invention

The present invention relates to a storage medium storing program capable of being read by computer, a computer program product, a navigator and a control method thereof, and more particularly to a navigator for capturing and sharing images while making a turn and a control method thereof.

2. Description of the Related Art

Presently, a conventional navigator system receives a real-time position signal as the location transmitted from a global positioning system and incorporates with map information loaded by navigation software to provide automobile navigation service. The most frequently seen way of navigation is that an automobile location is taken as an initial position, and a user inputs a destination. The automobile navigator system then calculates the shortest distance between the initial position and the destination position to provide the user for reference. However, the foregoing navigator system still has some problems that need to be overcome in actual operation. For example, while in a travel, only few members in a group own the navigator system. It would be so difficult to round up these members once some members whom do not carry the navigator system leave, especially for an area arrived at first time. When a road condition is not familiar, using phones for communication may get half the result with twice the effort. For example, when the members who got lost are notified to make a turn at an intersection, these members usually miss the timing to make a turn due to unfamiliar road and street conditions. Consequently, the members then get lose again and are unable to meet other members. The conventional navigator system can merely lead owners to the right location and may not ensure that other members could smoothly reach the destination.

### SUMMARY OF THE INVENTION

In view of the shortcomings of the prior art, the inventors of the present invention based on years of experience in the related industry to conduct extensive researches and experiments, and finally developed a storage medium saving a program and capable of being read by a computer, a computer program product, a navigator and its control method to overcome the problem of missing a turn at once due to unfamiliar road or street condition when a user that uses a navigator system is navigated to make a turn.

According to the object of the invention, a navigator is provided. The navigator comprises a positioning unit, an image capturing unit and a processing unit. The positioning unit positions the navigator and correspondingly provides positioning information. The image capturing unit captures a plurality of road images. The processing unit is electrically connected to a positioning unit and an image capturing unit and determines whether or not the navigator enters a turn state based upon a navigation route and positioning information. When the navigator enters the turn state, the processing unit controls the image capturing unit to capture the plurality of road images.

The navigator further comprises a storing unit and a route planning unit. The storing unit is electrically connected to the processing unit and is saved with a plurality of electronic maps. The processing unit saves the road images captured by the image capturing unit in the storing unit. The route planning unit is electrically connected to the processing unit and generates the navigation route based upon an initial position, a destination position and the electronic maps.

The navigator further comprises a display unit and a communication unit. The display unit is electrically connected to the processing unit to display the navigation route. The communication unit is electrically connected to the processing unit and transmits the road images to a remote device.

When the processing unit determines that the navigator enters the turn state, the processing unit searches whether or not the correspondingly road images have been saved in the storing unit. The processing unit immediately controls the display unit to display the road images when the processing unit searches the correspondingly road images.

According to the objective of the invention, a method for controlling a navigator is provided, wherein the navigator comprises a positioning unit, an image capturing unit and a processing unit. The method for controlling a navigator comprises the following steps of positioning the navigator and correspondingly providing positioning information through the positioning unit; determining whether or not the navigator enters a turn state based upon a navigation route and positioning information through the processing unit; and controlling the image capturing unit to capture a plurality of road images through the processing unit when the navigator enters the turn state.

The method for controlling the navigator further comprises the following steps of saving a plurality of electronic maps through a storing unit and saving the road images captured by the image capturing unit in the storing unit through the processing unit; and generating the navigation route based upon an initial position, a destination position and the electronic maps through a route planning unit.

The method for controlling the navigator further comprises the following steps of displaying the navigation route through a display unit; and transmitting the road images to a remote device through a communication unit.

The method for controlling the navigator further comprises the following steps of searching whether or not the corresponding road images have been saved in the storing unit through the processing unit when the processing unit determines that the navigator enters the turn state; and controlling the display unit to display the corresponding road images through the processing unit when the processing unit searches correspondingly road images.

According to the objective of the invention, a computer program product is further provided. After the computer loads and executes the program, the steps depicted in the method for controlling a navigator can be completed.

According to the objective of the invention, storage medium saving a program and capable of being read by a computer is further provided. After the computer loads and executes the program, the steps depicted in the method for controlling a navigator can be completed.

The storage medium saving a program and capable of being read by a computer, the computer program product, the navigator and its control method have one or more advantages:
(1) The navigator and its control method can take pictures to other users for references by determining whether or not a vehicle is at a turn state, thereby enhancing the successful rate in navigation.
(2) The navigator and its control method can upload and transmit the navigation route and the pictures about the turn state to other mobile electronic devices. Accordingly, the problem of leaving the lane due to insufficient navigation systems can be overcome.

### BRIEF DESCRIPTION OF THE DRAWINGS

FIG. 1 is a block diagram of a navigator according to the present invention;

FIG. 2 is a schematic diagram of a navigator according to a first embodiment of the present invention;

FIG. 3 is a schematic diagram of a navigator according to a second embodiment of the present invention;

FIG. 4 is a schematic diagram of a navigator according to a third embodiment of the present invention;

FIG. 5 is a flowchart of a method for controlling a navigator according to the present invention;

FIG. 6 is another flowchart of a method for controlling a navigator according to the present invention; and

FIG. 7 is a further flowchart of a method for controlling a navigator according to the present invention.

### DETAILED DESCRIPTION OF THE PREFERRED EMBODIMENTS

The foregoing and other technical characteristics of the present invention will become apparent with the detailed description of the preferred embodiments and the illustration of the related drawings.

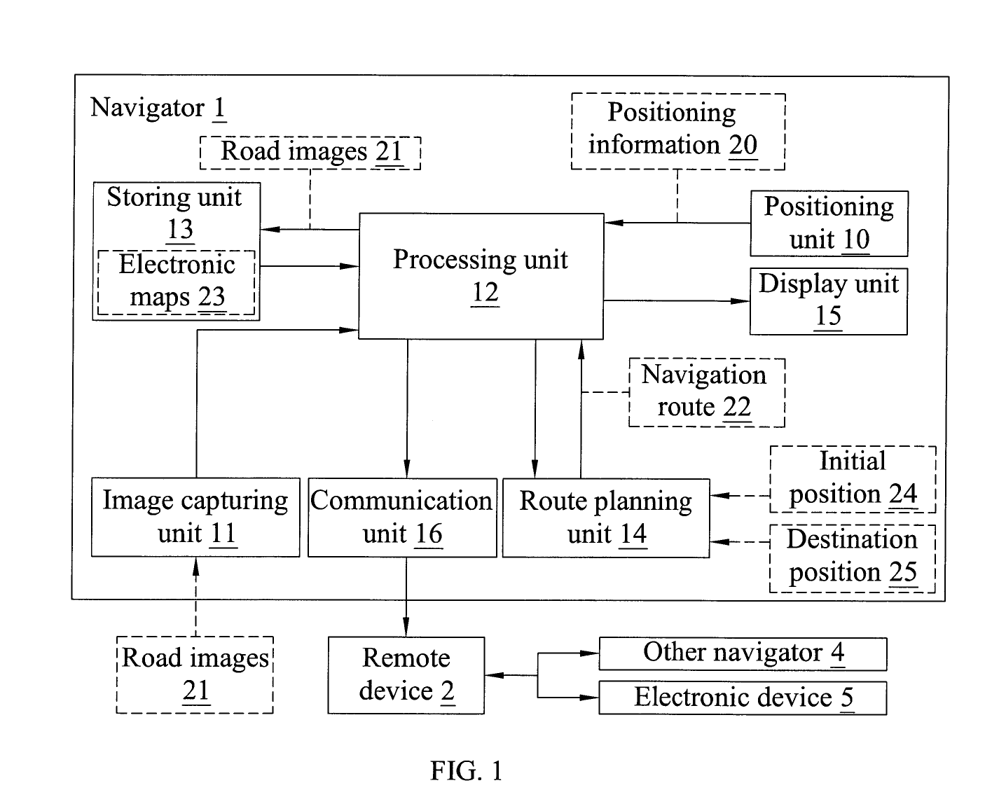

With reference to FIG. 1 for a block diagram of a navigator in accordance with the invention is depicted. The navigator 1 of the invention comprises a positioning unit 10, an image capturing unit 11, a processing unit 12, a storing unit 13, a route planning unit 14, a display unit 15 and a communication unit 16, wherein the processing unit 12 is electrically connected to the positioning unit 10, the image capturing unit 11, the processing unit 13, the route planning unit 14, the display unit 15 and the communication unit 16.

The positioning unit 10 positions the navigator 1 and correspondingly provides positioning information 20. In a preferred embodiment, the positioning unit 20 can be a global positioning system (GPS) and calculates the location of the navigator to provide positioning information 20 after receiving satellite signals. The image capturing unit 11 captures a plurality of road images 21 and at least comprises a photosensitive element, such as a complementary metal-oxide semiconductor (CMOS) or a charge-coupled device (CCD), a lens and a lens set. The processing unit 12 can be a central processing unit (CPU) or a microprocessor, and the processing unit 12 determines whether or not the navigator 1 enters a turn state based upon a navigation route 22 and positioning information 20. When the navigator 1 enters the turn state, the processing unit 12 controls the image capturing unit 11 capturing the plurality of road images 21.

In addition, the storing unit 13 can be diversity of storage mediums, such as an embedding memory, an external memory card, a disc or a compact disc, and stores a plurality of electronic maps 23. The processing unit 12 further stores the road images 21 captured by the image capturing unit 11 in the storing unit 13. The route planning unit 14, the positioning unit 10 and the communication unit 16 can be respectively independent operation chipsets and can also be integrated with the processing unit 12 into the same operation chipset. The route planning unit 14 generates a navigation route 22 based upon an initial position 24, a destination position 25 and the electronic maps 23. The display unit 15 can be diversity of display devices, such as liquid crystal displays, projectors, organic light emitting diode displays or electronic papers, and is used for displaying the navigation route 22 and the road images 21. The communication unit 16 can be different kinds of wired or wireless communication devices such as 3G, WIFI, WIMAX, LTE or LAN. The communication unit 16 transmits the road images 21 and the navigation route 22 to a remote device 2. Moreover, in some preferred embodiments, when the processing unit 12 determines that the navigator 1 enters a turn state, the processing unit 12 searches whether or not the storing unit 13 stores correspondingly road images 21. When the processing unit 12 found the correspondingly road images 21, the processing unit 12 controls the display unit 15 to display the road images 21.

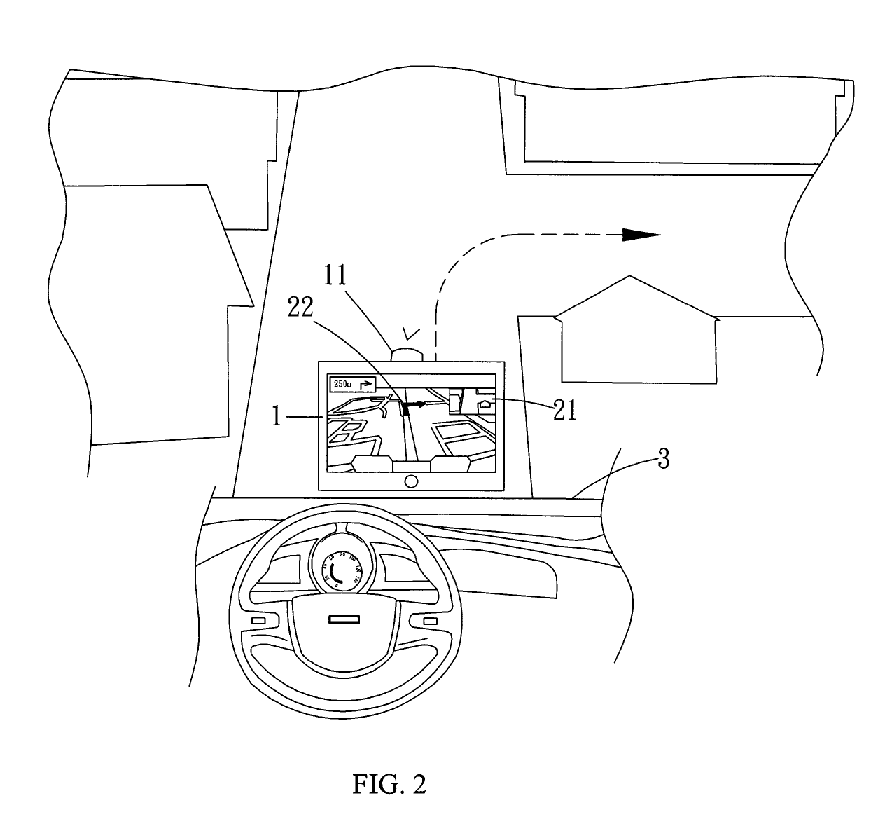

With reference to FIG. 2 for a schematic diagram of a navigator in accordance with a first embodiment of the present invention is depicted. The processing unit 12 of the navigator 1 of the invention determines whether or not a vehicle 3 (e.g. an automobile) carrying the navigator 1 is making a turn based upon positioning information 20. For example, when the vehicle 3 makes a right turn to an alley, the processing unit 12 controls the image capturing unit 11 to capture the road images 21 at the turn, and the road images 21 then are saved in the storing unit 13. After completing the navigation, the control unit 12 further uploads the navigation route 22 and the captured pictures (the road images 21) to the remote device 2 through the communication unit 16. This remote device 2 can be a remote server. The remote server can actively or passively transmit the navigation route 22 and captured pictures at each turn to other navigator 4 or any electronic device 5, such as laptop computers, mobile phones and PDAs, capable of displaying the navigation route 22 and the captured pictures at each turn. Accordingly, a user who holds these electronic devices can easily reach the destination through the navigation route and the captured pictures provided by the navigator without missing the timing to make a turn.

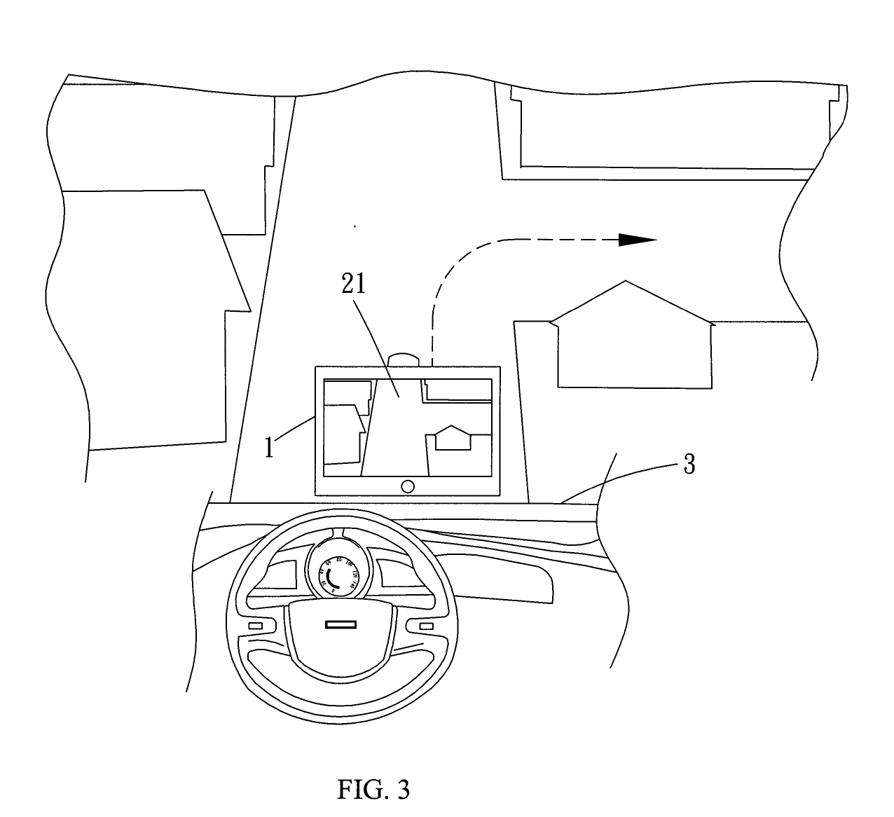

With reference to FIG. 3 for a schematic diagram of a navigator in accordance with a second embodiment of the present invention is depicted. The processing unit 12 of the navigator 1 of the invention determines whether or not the vehicle 3 carrying the navigator 1 is making a turn. For example, the processing unit 12 further searches whether or not the road images 21 corresponding to the turn have been saved in the storing unit 13. When the processing unit 12 searches the road images 21 corresponding to the turn, the processing unit 12 does not control the image capturing unit 11 to capture the image with respect to a curved channel and controls the display unit 15 to display the road images 21. The display manner is to display the whole screen so that a driver can easily confirm that he/she must make a turn at the curved channel. Alternatively, the display manner is also to display a portion of screen to remind the driver without restriction herein.

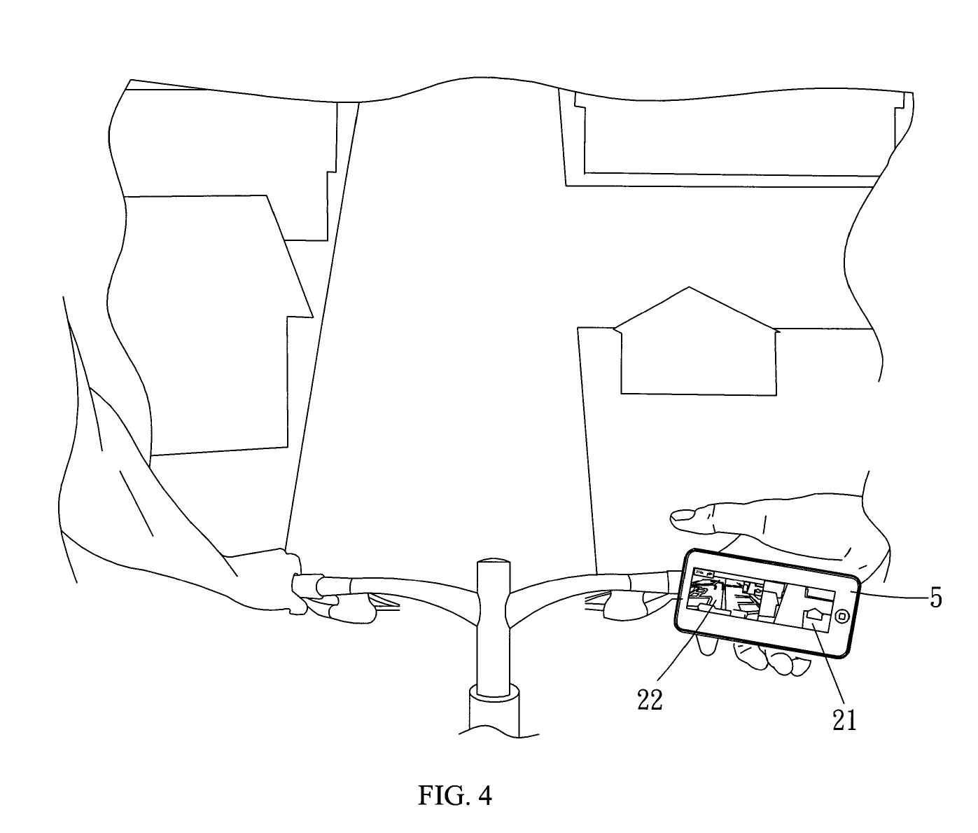

With reference to FIG. 4 for a schematic diagram of a navigator in accordance with a third embodiment of the present invention is depicted. The embodiment shows that other vehicle (e.g. a bicycle) is allowed to determine whether or not a turn should be performed. After the electronic device 5 (e.g. the mobile phone) held by a hand of a bicycle driver downloads the navigation route and the pictures about the turn through a server of the remote device 2, both navigation route and the pictures can be displayed on the mobile phone. Accordingly, the bicycle driver as a user can make an accurate turn after performing confirmation.

In the process of depicting the navigator of the invention, although the concept of the method for controlling the navigator of the invention has been depicted simultaneously, a flowchart is also provided to clearly depict the method.

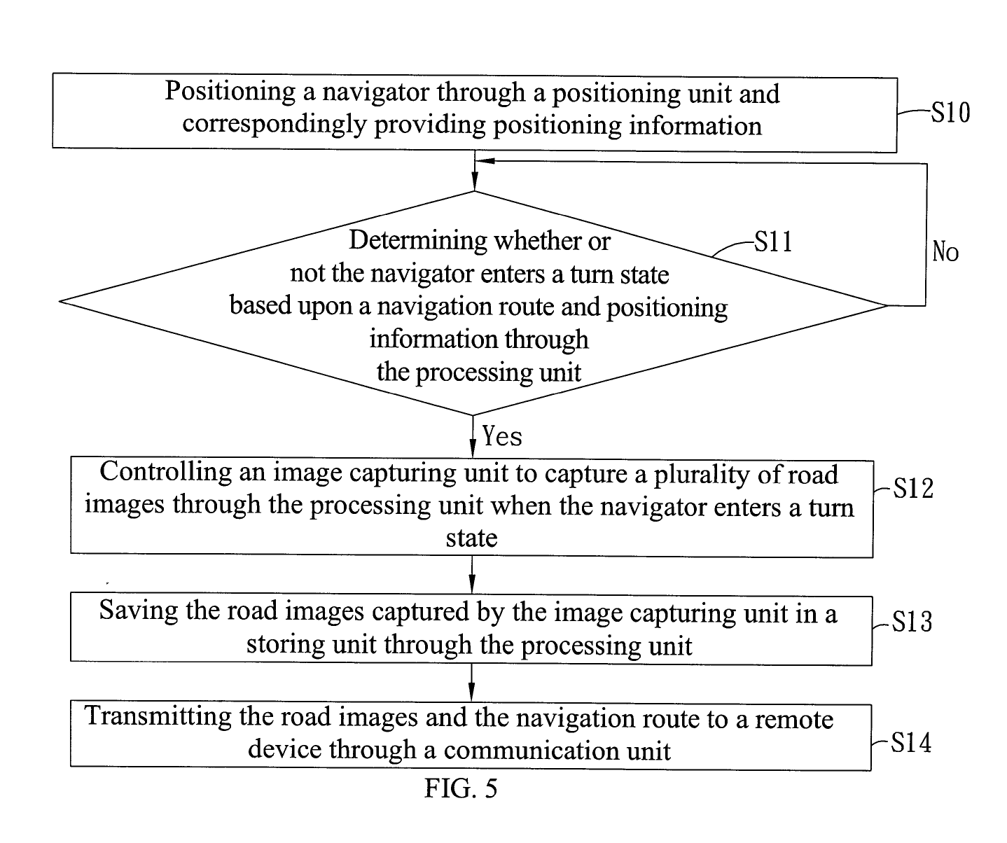

With reference to FIG. 5 for a flowchart of a method for controlling a navigator in accordance with the present invention is depicted. The method for controlling the navigator of the invention is suitable for the navigator and comprises a positioning unit, an image capturing unit, a processing unit, a storing unit, a route planning unit, a display unit and a communication unit. The method for controlling the navigator comprises the following steps:

(S10) Positioning a navigator through a positioning unit and correspondingly providing positioning information;

(S11) Determining whether or not the navigator enters a turn state based upon a navigation route and positioning information through the processing unit;

(S12) Controlling an image capturing unit to capture a plurality of road images through the processing unit when the navigator enters a turn state;

(S13) Saving the road images captured by the image capturing unit in the storing unit through the processing unit; and

(S14) Transmitting the road images and the navigation route to a remote device through the communication unit.

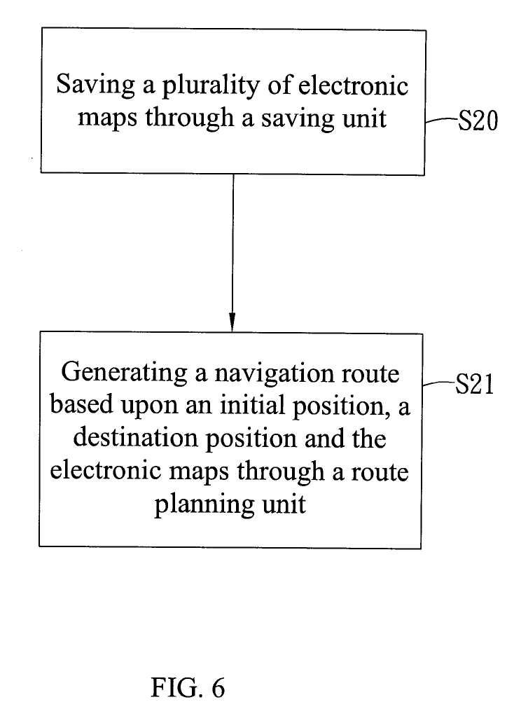

With reference to FIG. 6 for another flowchart of a method for controlling a navigator in accordance with the present invention is depicted. The method for controlling the navigator of the invention further comprises the following steps:

(S20) Saving a plurality of electronic maps through a saving unit; and

(S21) Generating a navigation route based upon an initial position, a destination position and the electronic maps through a route planning unit.

Steps (S20) and (S21) can be preferably performed before step (S10), but the invention does not limit the successive sequence.

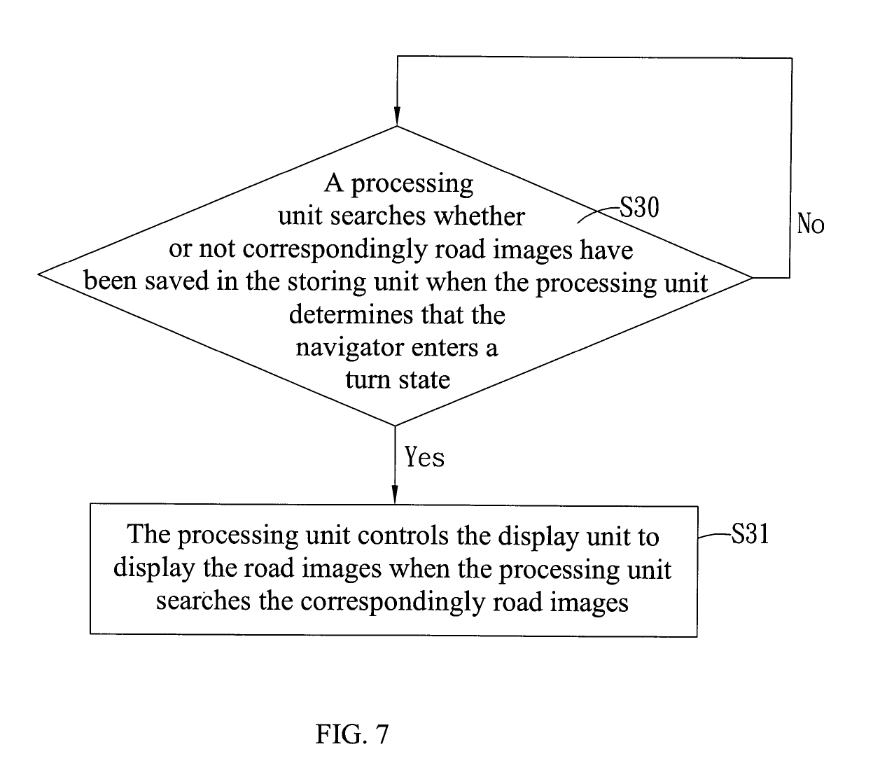

With reference to FIG. 7 for a further flowchart of a method for controlling a navigator in accordance with the present invention is depicted. The method for controlling a navigator of the invention further comprises the following steps:

(S30) A processing unit searches whether or not correspondingly road images have been saved in the storing unit when the processing unit determines that the navigator enters a turn state; and

(S31) The processing unit controls the display unit to display the road images when the processing unit searches the correspondingly road images.

Step (S30) can be performed after step (S12) and performed together with step (S13), but the invention does not limit the successive sequence.

The detail implementation of foregoing each step has been depicted in the forgoing navigator and does not need to be repeated herein.

In addition, the invention further provides storage medium saving a program and capable of being read by computers and a computer program product. The computer comprises but not limited to a positioning unit, an image capturing unit, a processing unit, a storing unit, a route planning unit, a display unit and a communication unit. The storage medium can be a compact disc, a hard drive, a flash drive or other similar storage medium. After the program is loaded and executed by the computer, it can complete the method as well as step (S10) to step (S31) depicted in the method for controlling the navigator.

The storage medium saving programs and capable of being read by computers, the computer program product, the navigator and its control method can take pictures for reference by determining whether or not a vehicle is at a turn state so as to enhance the successful rate in navigation. Further, the navigation route and the pictures about a turn state can be uploaded and transmitted to other electronic devices, and the problem of leaving the lane due to insufficient navigation systems can be overcome.

The invention improves over the prior art and complies with patent application requirements, and thus is duly filed for patent application. While the invention has been described by device of specific embodiments, numerous modifications and variations could be made thereto by those generally skilled in the art without departing from the scope and spirit of the invention set forth in the claims.

What is claimed is:

1. A navigator comprising:
a positioning unit for positioning the navigator and correspondingly providing positioning information;
an image capturing unit for capturing a plurality of road images; and
a processing unit electrically connected to the positioning unit and the image capturing unit for determining whether or not the navigator enters a turn state based upon a navigation route and the positioning information, wherein the processing unit controls the image capturing unit to capture the plurality of road images when the navigator enters the turn state.

2. The navigator as recited in claim 1, further comprising:
a storing unit electrically connected to the processing unit for saving a plurality of electronic maps, the processing unit saving the plurality of road images captured by the image capturing unit in the storing unit; and
a route planning unit electrically connected to the processing unit for generating the navigation route based upon an initial position, a destination position and the plurality of electronic maps.

3. The navigator as recited in claim 2, further comprising:
a display unit electrically connected to the processing unit for displaying the navigation route; and
a communication unit electrically connected to the processing unit for transmitting the plurality of road images to a remote device.

4. The navigator as recited in claim 3, wherein the processing unit searches whether or not the plurality of road images is saved in the storing unit when the processing unit determines that the navigator enters the turn state, and when the processing unit searches the plurality of road images, the processing unit controls the display unit to display the plurality of road images.

5. A method for controlling a navigator, the navigator comprising a positioning unit, an image capturing unit and a processing unit, the method for controlling the navigator comprising following steps:
positioning the navigator and correspondingly providing positioning information through the positioning unit;
determining whether or not the navigator enters a turn state based upon a navigation route and the positioning information through the processing unit; and
controlling the image capturing unit to capture a plurality of road images through the processing unit when the navigator enters the turn state.

6. The method for controlling a navigator as recited in claim 5, further comprising following steps:
saving a plurality of electronic maps through a storing unit, wherein the processing unit saves the plurality of road images captured by the image capturing unit in the storing unit; and
generating the navigation route based upon an initial position, a destination position and the plurality of electronic maps through a route planning unit.

7. The method for controlling a navigator as recited in claim 6, further comprising following steps:
displaying the navigation route through a display unit; and
transmitting the plurality of road images to a remote device through a communication unit.

8. The method for controlling a navigator as recited in claim 7, further comprising following steps:
searching whether or not the plurality of road images is saved in the storing unit through the processing unit when the processing unit determines the navigator enters the turn state; and
controlling the display unit to display the plurality of road images through the processing unit when the processing unit searches the plurality of road images.

9. A storage medium saving a program and capable of being read by a computer, the storage medium completing the method as recited in claim 5 after the computer loads and executes the program.

10. A storage medium saving a program and capable of being read by a computer, the storage medium completing the method as recited in claim 6 after the computer loads and executes the program.

11. A storage medium saving a program and capable of being read by a computer, the storage medium completing the method as recited in claim 7 after the computer loads and executes the program.

12. A storage medium saving a program and capable of being read by a computer, the storage medium completing the method as recited in claim 8 after the computer loads and executes the program.

13. A computer program product completing the method as recited in claim 5, after the computer loads and executes the program.

14. A computer program product completing the method as recited in claim 6 after the computer loads and executes the program.

15. A computer program product completing the method as recited in claim 7 after the computer loads and executes the program.

16. A computer program product completing the method as recited in claim 8 after the computer loads and executes the program.
